(19) United States
(12) Patent Application Publication
(10) Pub. No.: US 2026/0113410 A1
(43) Pub. Date: Apr. 23, 2026

(54) CONFIDENTIAL DOCUMENT TRANSMISSION SYSTEM AND METHOD THEREOF

(71) Applicant: Teco Image Systems Co., Ltd., Taipei City (TW)

(72) Inventor: Chih-Min Lin, Taipei City (TW)

(21) Appl. No.: 18/932,257

(22) Filed: Oct. 30, 2024

(30) Foreign Application Priority Data
Oct. 21, 2024 (TW) 113139865

(51) Int. Cl. H04N 1/44; H04N 1/00

(52) U.S. Cl. CPC H04N 1/4413; H04N 1/00212; H04N 2201/0094

(57) ABSTRACT

A confidential document transmission system and a method thereof are disclosed. The method includes the steps of: (a) a sender inputting a receiver email mailbox through a multi-function printer (MFP); (b) the sender scanning a document through the MFP and transmitting the document to a cloud space address; (c) the MFP generating an address QR-CODE based on the cloud space address, and sending the address QR-CODE to the receiver email mailbox; (d) the MFP generating a password QR-CODE based on the document scanned, and outputting the password QR-CODE; (e) the sender sending the password QR-CODE to the receiver email mailbox; and (f) the receiver logging in to the cloud space address, and accessing the document according to the password QR-CODE.

### CROSS-REFERENCE TO RELATED APPLICATION

This application claims priority to Taiwan Patent Application No. 113139865, filed on October 21, 2024. The entireties of the above-mentioned patent application are incorporated herein by reference for all purposes.

### FIELD OF THE INVENTION

The present disclosure relates to a document processing system, and more particularly to a confidential document transmission system and a method thereof, wherein the document is scanned and transmitted to the cloud for storage, and then the user accesses the document the through a QR-CODE method, so as to take into account the convenience and the confidentiality of data access at the same time.

### BACKGROUND OF THE INVENTION

Generally speaking, common information security issues on the Internet need to be solved through the encryption technology. In order to securely transmit the confidential document, the original owner of the confidential document has to encrypt the confidential document file and then sends the encrypted file to the recipient of the document. On the other hand, the original owner of the confidential document sends a corresponding password to the recipient of the document in another letter or other channel. After receiving the password, the recipient loads the encrypted files and then manually enters the password to fully open the encrypted file.

The current mechanism for scanning a confidential document needs to encrypt the scanned document with a password and then transmits the scanned document to the recipient. Then, another channel is used to send the password to the recipient to access the encrypted file. If the scanning of confidential documents is not managed, the user may have the confidential documents scanned to the user's inbox or flash drive. This will lead to data theft issues. In other words, files may be stolen before they are encrypted. On the other hand, if the file password is too short, it may be easily cracked, and if the file password is too complex, it will be difficult to remember.

Therefore, there is a need of providing a confidential document transmission system and a method thereof, wherein the document is scanned and transmitted to the cloud for storage, and then the user accesses the document the through a QR-CODE method, so as to take into account the convenience and the confidentiality of data access at the same time, and obviate the drawbacks encountered from the prior arts.

### SUMMARY OF THE INVENTION

It is an object of the present disclosure to provide a confidential document transmission system and a method thereof, wherein the document is scanned and transmitted to the cloud for storage, and then the user accesses the document the through a QR-CODE method, so as to take into account the convenience and the confidentiality of data access at the same time.

It is another object of the present disclosure to provide a confidential document transmission system and a method thereof. A confidential document is sent to a cloud space address for encrypted storage through the scanning function of a multi-function printer (MFP). At the same time, a corresponding password QR-CODE is generated and given to the sender from the MFP. In this way, it can prevent the user from scanning the confidential document to the user's inbox or flash drive. In the confidential document transmission system of the present disclosure, the recipient can obtain the cloud space address where the confidential document is stored through the email combined with the address QR-CODE or other channels. At the same time, the sender can send the password QR-CODE to the recipient through the email or other means. If the recipient wants to successfully download the scanned and uploaded confidential document from the cloud space address, the recipient has to obtain the cloud space address and the corresponding password QR-CODE. Preferably but not exclusively, the password QR-CODE is a text QR-CODE or an image QR-CODE, so that a complex and highly confidential password can be constructed, and the characteristic information of the sender is combined therewith. Then, the password QR-CODE is sent to the recipient. When the recipient wants to download the confidential document from the cloud space address, there is no need to input a complex password anymore. The recipient only needs to provide the received password QR-CODE to download the confidential document from the cloud space address, so that the convenience and the confidentiality of data access are taken into account at the same time. The present disclosure includes the industrial applicability and the inventive steps.

In accordance with an aspect of the present disclosure, a confidential document transmission method is provided and includes steps of: (a) a sender inputting a receiver email mailbox through a multi-function printer (MFP); (b) the sender scanning a document through the MFP and transmitting the document to a cloud space address; (c) the MFP generating an address QR-CODE based on the cloud space address, and sending the address QR-CODE to the receiver email mailbox; (d) the MFP generating a password QR-CODE based on the document scanned, and outputting the password QR-CODE; and (e) the sender sending the password QR-CODE to the receiver email mailbox.

In an embodiment, the step (b) further includes a step (b0) in which the sender sets or selects the cloud space address through the MFP.

In an embodiment, the step (d) further includes a step (d1) in which the MFP prints out the password QR-CODE in paper format.

In an embodiment, the step (a) further includes a step (a1) of the sender loading a sender email mailbox, and the step (d) further includes steps of: (d2) the MFP transmitting the password QR-CODE to the sender; and (d3) the sender sending the password QR-CODE to the receiver email mailbox.

In an embodiment, the confidential document transmission method further includes a step of (f) a receiver of the receiver email mailbox logging in to the cloud space address according to the address QR-CODE, and accessing the document according to the password QR-CODE.

In an embodiment, the password QR-CODE is a text QR-CODE or an image QR-CODE, which includes characteristic information of the sender or the receiver email mailbox.

In accordance with another aspect of the present disclosure, a confidential document transmission method is provided and includes steps of: (a) a sender inputting a receiver email mailbox through a multi-function printer (MFP); (b) the sender scanning a document through the MFP and transmitting the document to a cloud space address; (c) sending the cloud space address to the receiver email mailbox; (d) the MFP generating a password QR-CODE based on the document scanned, and outputting the password QR-CODE; and (e) the sender sending the password QR-CODE to the receiver email mailbox.

In an embodiment, the step (b) further includes a step (b0) in which the sender selects the cloud space address through the MFP.

In an embodiment, the step (d) further includes a step (d1) in which the MFP prints out the password QR-CODE in paper format.

In an embodiment, the step (a) further includes a step (a1) of the sender loading a sender email mailbox, and the step (d) further includes steps of: (d2) the MFP transmitting the password QR-CODE to the sender; and (d3) the sender sending the password QR-CODE to the receiver email mailbox.

In an embodiment, the confidential document transmission method further includes a step of (f) the receiver logging in to the cloud space address, and accessing the document according to the password QR-CODE.

In an embodiment, the password QR-CODE is a text QR-CODE or an image QR-CODE, which includes characteristic information of the sender or the receiver email mailbox.

In accordance with a further aspect of the present disclosure, a confidential document transmission system is provided and includes a cloud storage space and a multi-function printer (MFP). The MFP is connected to the cloud storage space through the Internet, wherein the MFP includes a scanner and a QR-CODE generator, wherein when a sender scans a document through the scanner, the MFP scans and sends the document to a cloud space address in the cloud storage space, the QR-CODE generator generates an address QR-CODE based on the cloud space address and a password QR-CODE based on the document scanned, the address QR-CODE is sent to a receiver email mailbox of a receiver, and the password QR-CODE is outputted to the sender.

In an embodiment, the MFP prints out the password QR-CODE in paper format.

In an embodiment, the MFP sends the password QR-CODE to a sender email mailbox of the sender.

In an embodiment, the document is a confidential document, and the MFP allows the sender to enter a confidential document scanning function, wherein the MFP pre-stores a sender email mailbox of the sender, and the sender selects the corresponding sender email mailbox and enters the confidential document scanning function to scan the document through the scanner of the MFP.

In an embodiment, the password QR-CODE is a text QR-CODE or an image QR-CODE, which includes characteristic information of the sender or the receiver email mailbox.

In an embodiment, the receiver logs in to the cloud space address according to the address QR-CODE, and access the document according to the password QR-CODE.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic structural diagram illustrating a confidential document transmission system according to a first embodiment of the present disclosure;

FIG. 2 is a flow chart illustrating the confidential document transmission method according to the first embodiment of the present disclosure;

FIG. 3 is a schematic structural diagram illustrating a confidential document transmission system according to a second embodiment of the present disclosure;

FIG. 4 is a flow chart illustrating the confidential document transmission method according to the second embodiment of the present disclosure; and

FIG. 5 is a schematic structural diagram illustrating a confidential document transmission system according to a third embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “inside,” “outside,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the "first," "second," "third," and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments.

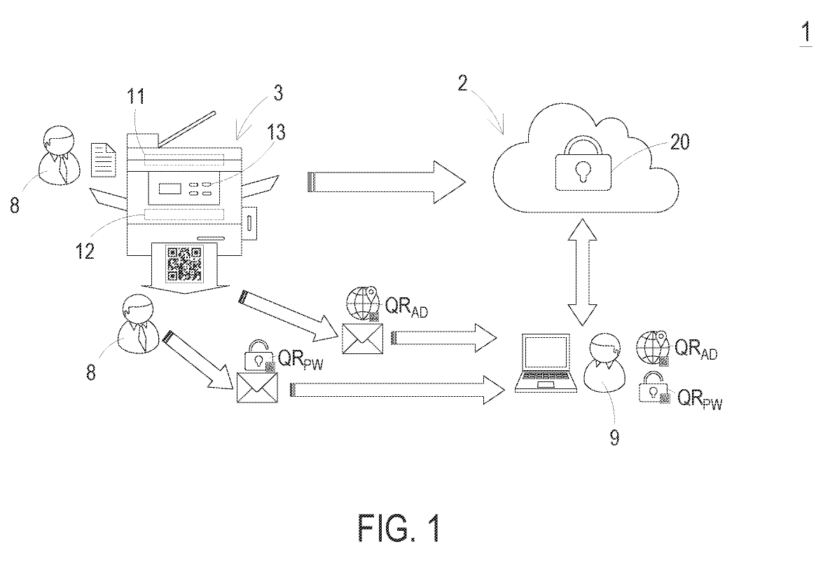

FIG. 1 is a schematic structural diagram illustrating a confidential document transmission system according to a first embodiment of the present disclosure. Referring to FIG. 1, the present disclosure provides a confidential document transmission system 1 and includes a cloud storage space 2 and a multi-function printer (MFP) 3. The MFP 3 is externally connected to the cloud storage space 2 through the Internet. The MFP 3 includes a scanner 11 and a QR-CODE generator 12 disposed inside. In the embodiment, the scanner 11 has a document scanning function, and the QR-CODE generator 12 can be composed of, for example but not limited to, hardware or software, and is configured to generate the required QR-CODE. In the embodiment, the scanner 11 and the QR-CODE generator 12 further collaborate to construct a document transmission function, where the document further refers to a confidential document with confidentiality requirements.

In the embodiment, when a sender 8 by the MFP3 scans a document through the scanner 11 of the MFP3, the MFP scans and sends the document to a cloud space address 20 in the cloud storage space 2. The QR-CODE generator 12 generates an address QR-CODE QR_{AD} based on the cloud space address 20 and a password QR-CODE QR_{PW} based on the document scanned. The address QR-CODE QR_{AD} is sent to a receiver email mailbox of a receiver 9, so that the recipient 9 is informed of the cloud space address 20. On the other hand, the password QR-CODE QR_{PW} is outputted to the sender 8. The scanned document is transmitted and stored at the cloud space address 20, and the recipient 9 needs to obtain the password QR-CODE QR_{PW} sent by the sender 8 in order to download the corresponding document from the cloud space address 20. Preferably but not exclusively, in the embodiment, the password QR-CODE QR_{PW} generated by the QR-CODE generator 12 is a text QR-CODE or an image QR-CODE, so that a complex and highly confidential password can be constructed, and the characteristic information of the sender 8 is combined therewith for sending to the recipient 9. The recipient 9 needs to provide the received password QR-CODE QR_{PW}, so as to correspondingly download the confidential document at the cloud space address 20. There is no need to input a complex password anymore. Moreover, the convenience and the confidentiality of data access are taken into account at the same time.

Preferably but not exclusively, in the embodiment, the operation panel of the MFP 3 has a plurality of sender email mailboxes pre-stored therein, and the confidential document scanning function of the MFP 3 is allowed to be used only after the sender 8 selects the corresponding sender email mailbox. Certainly, in other embodiments, the sender 8 is allowed to input the sender email mailbox and the recipient email address through the operation panel of the MFP 3, so that the QR-CODE generator 12 can generate the password QR-CODE QR_{PW} for sending to the sender 8 and the address QR-CODE QR_{AD} for sending to the recipient 9, respectively. Certainly, the transmission channel of the address QR-CODE QR_{AD} and the password QR-CODE QR_{PW} is not limited to the email format, but adjustable according to the practical requirements.

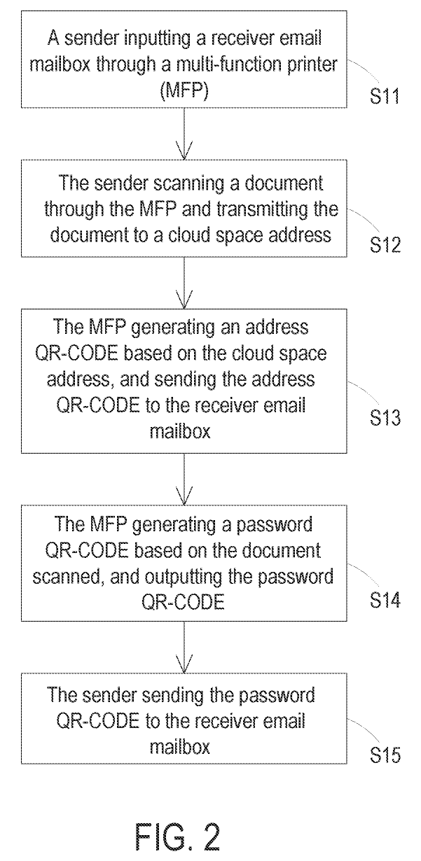

Based on the aforementioned confidential document transmission system 1, the present disclosure also provides a confidential document transmission method. FIG. 2 is a flow chart illustrating the confidential document transmission method according to the first embodiment of the present disclosure. Please refer to FIG. 1 and FIG. 2. In the embodiment, when the sender 8 wants to transmit a confidential document to the recipient 9, the sender 8 can start the MFP 3 and press a confidential document scanning function button 13, so that the operation panel of the MFP 3 enters the confidential document scanning menu for the confidential document transmission. Through the operation panel of the MFP 3, the sender 8 can input the recipient email mailbox of the recipient 9 or select one target from the recipient email mailboxes pre-stored in the MFP 3 for transmitting the confidential document, as shown in the step S11. Afterwards, the sender 8 scans the document through the scanner 11 of the MFP 3, and the scanned document is transmitted through the Internet and then stored in the cloud space address 20, as shown in the step S12. In addition, the QR-CODE generator 12 of the MFP 3 generates an address QR-CODE QR_{AD} based on the information of the cloud space address 20, and sends the address QR-CODE QR_{AD} to the recipient email mailbox of the recipient 9 via email, as shown in the step S13. The address QR-CODE QR_{AD} contains the information of the cloud space address 20. The recipient 9 only knows the storage address of the confidential document based on the received cloud space address 20, but the recipient 9 cannot download the corresponding confidential document yet. In the step S14, the QR-CODE generator 12 of the MFP 3 also generates a password QR-CODE QR_{PW} based on the information of the scanned document, and outputs the password QR-CODE QR_{PW} to the sender 8 on the MFP 3 side. Preferably but not exclusively, in the embodiment, the MFP 3 prints out the password QR-CODE QR_{PW} in paper format or sends the password QR-CODE QR_{PW} to the sender email mailbox of the sender 8 via email. The sender email mailbox may be selected from the sender email mailboxes pre-stored in the MFP 3 as the sender of the confidential document. Certainly, the present disclosure is not limited thereto. The sender 8 who has the password QR-CODE QR_{PW} then transmits the password QR-CODE QR_{PW} to the recipient email mailbox of the recipient 9 via email or other channels, as shown in the step S15. In this way, the recipient 9 can have the address QR-CODE QR_{AD} and the password QR-CODE QR_{PW} at the same time. The recipient 9 can log in to the cloud space address 20 according to the address QR-CODE QR_{AD}, and access the document according to the password QR-CODE QR_{PW}. That is, the corresponding confidential document can be downloaded from the cloud space address 20. It allows the sender 8 to transmit the confidential document to the recipient 9 through the confidential document transmission system 1 of the present disclosure, and the convenience and confidentiality of data access are taken into account at the same time.

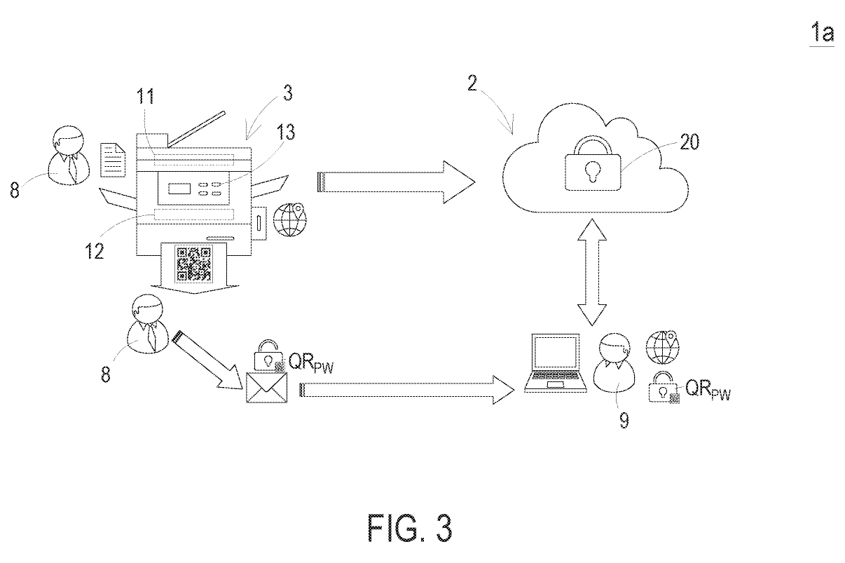

FIG. 3 is a schematic structural diagram illustrating a confidential document transmission system according to a second embodiment of the present disclosure. In the embodiment, the structures, elements and functions of the confidential document transmission system 1a are similar to those of the confidential document transmission system 1 in FIG. 1, and are not redundantly described herein. In the embodiment, the cloud space address 20 of the cloud storage space 2 is public information, which both the sender 8 and the recipient 9 can know in advance. Preferably but not exclusively, in other embodiments, the cloud storage space 2 is replaced by the storage space in a local network. The present disclosure is not limited thereto.

In the embodiment, when a sender 8 wants to transmit a confidential document to the recipient 9, the sender 8 can start the MFP 3 and press the confidential document scanning function button 13, so that the operation panel of the MFP 3 enters the confidential document scanning menu for the confidential document transmission. One cloud space address 20 pre-stored is selected for transmitting the confidential document. When the sender 8 by the MFP3 scans the document through the scanner 11 of the MFP3, the MFP scans and sends the document to the cloud space address 20 selected in the cloud storage space 2. The QR-CODE generator 12 generates a password QR-CODE QR_{PW} based on the document scanned, and the password QR-CODE QR_{PW} is outputted to the sender 8. The sender 8 who has the password QR-CODE QR_{PW} then transmits the password QR-CODE QR_{PW} to the recipient 9 via email or other channels. The recipient 9 can log in to the cloud space address 20 known in advance and use the received password QR-CODE QR_{PW} to correspondingly download the confidential document. There is no need to input a complex password anymore. The convenience and the confidentiality of data access are taken into account at the same time.

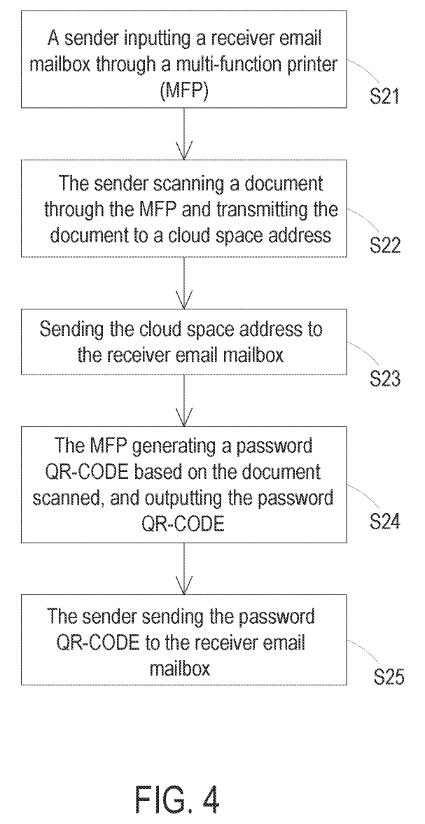

Based on the aforementioned confidential document transmission system 1a, the present disclosure also provides a confidential document transmission method. FIG. 4 is a flow chart illustrating the confidential document transmission method according to the second embodiment of the present disclosure. Please refer to FIG. 3 and FIG. 4. In the embodiment, when the sender 8 wants to transmit a confidential document to the recipient 9, the sender 8 can input the recipient email mailbox of the recipient 9 or select one target from the recipient email mailboxes pre-stored in the MFP 3 for transmitting the confidential document, as shown in the step S21. Afterwards, the sender 8 scans the document through the scanner 11 of the MFP 3, and the scanned document is transmitted through the Internet and then stored in the cloud space address 20 pre-set in advance, as shown in the step S22. In addition, the MFP 3 sends the preset cloud space address 20 to the recipient email mailbox of the recipient 9 via email, as shown in the step S23. The recipient 9 can knows that the confidential document has been stored in the preset cloud space address 20 based on the information of the received email, but the recipient 9 cannot download the corresponding confidential document yet. In the step S24, the QR-CODE generator 12 of the MFP 3 generates a password QR-CODE QR_{PW} based on the information of the scanned document, and outputs the password QR-CODE QR_{PW} to the sender 8 on the MFP 3 side. Preferably but not exclusively, in the embodiment, the MFP 3 prints out the password QR-CODE QR_{PW} in paper format or sends the password QR-CODE QR_{PW} to the sender email mailbox of the sender 8 via email. The sender 8 who has the password QR-CODE QR_{PW} then transmits the password QR-CODE QR_{PW} to the recipient email mailbox of the recipient 9 via email or other channels, as shown in the step S25. In this way, the recipient 9 can have the password QR-CODE QR_{PW}. It allows the recipient 9 to log in to the cloud space address 20 set in advance, and access the document according to the password QR-CODE QR_{PW}. That is, the confidential document transmission system 1a is used to complete the transmission of the confidential document, and the convenience and confidentiality of data access are taken into account at the same time.

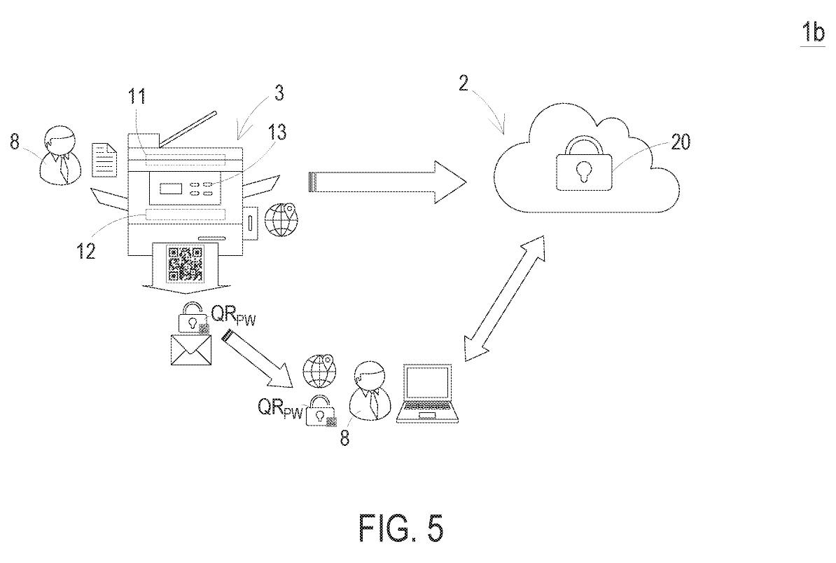

FIG. 5 is a schematic structural diagram illustrating a confidential document transmission system according to a third embodiment of the present disclosure. In the embodiment, the structures, elements and functions of the confidential document transmission system 1b are similar to those of the confidential document transmission system 1a in FIG. 3, and are not redundantly described herein. In the embodiment, when a sender 8 uses the confidential document transmission system 1b to scan a confidential document, the sender 8 can start the MFP 3 and press the confidential document scanning function button 13, so that the operation panel of the MFP 3 enters the confidential document scanning menu for the confidential document transmission. Preferably but not exclusively, the sender 8 selects himself as the recipient, and input the sender email mailbox. The confidential document scanned by the MFP 3 is transmitted through the Internet to the cloud space address 20 for encrypted storage. In the embodiment, the sender 8 cannot store the scanned confidential document from the MFP 3 to the user's inbox or flash drive for use directly. While the document scanned through the scanner 11 of the MFP 3 is transmitted and stored to the cloud space address 20 selected in the cloud storage space 2, the QR-CODE generator 12 further generates a password QR-CODE QR_{PW} based on the document scanned. Moreover, the generated password QR-CODE QR_{PW} is sent to the sender email mailbox of the sender 8 via email. At this time, the sender 8 having the password QR-CODE QR_{PW} can log in to the cloud space address 20 known in advance and use the received password QR-CODE QR_{PW} to download the confidential document. There is no need to input a complex password anymore. The convenience and the confidentiality of data access are taken into account at the same time. It further avoids the data theft issues. Certainly, the present disclosure is not limited thereto.

Notably, in the foregoing embodiments, it allows the sender 8 to use the confidential document transmission systems 1, 1a, 1b to implement the confidential document management. Preferably but not exclusively, in an embodiment, the address QR-CODE QR_{AD} and password QR-CODE QR_{PW} generated by the QR-CODE generator 12 of the MFP 3 is a text QR-CODE or an image QR-CODE, which includes the characteristic information of the sender 8 or the recipient email mailbox, so that each confidential document processed by the confidential document transmission system 1, 1a, 1b is recorded and controlled. In addition, the scanned confidential documents are centrally stored in the cloud storage space 2 for easy management and storage. The recipient 9 who holds the cloud space address 20 (or address QR-CODE QR_{AD}) and the password QR-CODE QR_{PW} is allowed to download the corresponding document from the cloud storage space 2 at any time. Certainly, the present disclosure is not limited thereto and not redundantly described hereafter.

In summary, the present disclosure provides a confidential document transmission system and a method thereof, wherein the document is scanned and transmitted to the cloud for storage, and then the user accesses the document the through a QR-CODE method, so as to take into account the convenience and the confidentiality of data access at the same time. A confidential document is sent to a cloud space address for encrypted storage through the scanning function of a multi-function printer (MFP). At the same time, a corresponding password QR-CODE is generated and given to the sender from the MFP. In this way, it can prevent the user from scanning the confidential document to the user's inbox or flash drive. In the confidential document transmission system of the present disclosure, the recipient can obtain the cloud space address where the confidential document is stored through the email combined with the address QR-CODE or other channels. At the same time, the sender can send the password QR-CODE to the recipient through the email or other means. If the recipient wants to successfully download the scanned and uploaded confidential document from the cloud space address, the recipient has to obtain the cloud space address and the corresponding password QR-CODE. Preferably but not exclusively, the password QR-CODE is a text QR-CODE or an image QR-CODE, so that a complex and highly confidential password can be constructed, and the characteristic information of the sender is combined therewith. Then, the password QR-CODE is sent to the recipient. When the recipient wants to download the confidential document from the cloud space address, there is no need to input a complex password anymore. The recipient only needs to provide the received password QR-CODE to download the confidential document from the cloud space address, so that the convenience and the confidentiality of data access are taken into account at the same time. The present disclosure includes the industrial applicability and the inventive steps.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A confidential document transmission method, comprising steps of:
(a) a sender inputting a receiver email mailbox through a multi-function printer (MFP);
(b) the sender scanning a document through the MFP and transmitting the document to a cloud space address;
(c) the MFP generating an address QR-CODE based on the cloud space address, and sending the address QR-CODE to the receiver email mailbox;
(d) the MFP generating a password QR-CODE based on the document scanned, and outputting the password QR-CODE; and
(e) the sender sending the password QR-CODE to the receiver email mailbox.

2. The confidential document transmission method according to claim 1, wherein the step (b) further comprises a step (b0) in which the sender sets or selects the cloud space address through the MFP.

3. The confidential document transmission method according to claim 1, wherein the step (d) further comprises a step (d1) in which the MFP prints out the password QR-CODE in paper format.

4. The confidential document transmission method according to claim 1, wherein the step (a) further comprises a step (a1) of the sender loading a sender email mailbox, and the step (d) further comprises steps of:
(d2) the MFP transmitting the password QR-CODE to the sender; and
(d3) the sender sending the password QR-CODE to the receiver email mailbox.

5. The confidential document transmission method according to claim 4, further comprising a step of (f) a receiver of the receiver email mailbox logging in to the cloud space address according to the address QR-CODE, and accessing the document according to the password QR-CODE.

6. The confidential document transmission method according to claim 1, further comprising a step of (f) a receiver of the receiver email mailbox logging in to the cloud space address according to the address QR-CODE, and accessing the document according to the password QR-CODE.

7. The confidential document transmission method according to claim 1, wherein the password QR-CODE is a text QR-CODE or an image QR-CODE, which comprises characteristic information of the sender or the receiver email mailbox.

8. A confidential document transmission method, comprising steps of:
(a) a sender inputting a receiver email mailbox through a multi-function printer (MFP);
(b) the sender scanning a document through the MFP and transmitting the document to a cloud space address;
(c) sending the cloud space address to the receiver email mailbox;
(d) the MFP generating a password QR-CODE based on the document scanned, and outputting the password QR-CODE; and
(e) the sender sending the password QR-CODE to the receiver email mailbox.

9. The confidential document transmission method according to claim 8, wherein the step (b) further comprises a step (b0) in which the sender selects the cloud space address through the MFP.

10. The confidential document transmission method according to claim 8, wherein the step (d) further comprises a step (d1) in which the MFP prints out the password QR-CODE in paper format.

11. The confidential document transmission method according to claim 8, wherein the step (a) further comprises a step (a1) of the sender loading a sender email mailbox, and the step (d) further comprises steps of:
(d2) the MFP transmitting the password QR-CODE to the sender; and
(d3) the sender sending the password QR-CODE to the receiver email mailbox.

12. The confidential document transmission method according to claim 11, further comprising a step of (f) the receiver logging in to the cloud space address, and accessing the document according to the password QR-CODE.

13. The confidential document transmission method according to claim 8, further comprising a step of (f) the receiver logging in to the cloud space address, and accessing the document according to the password QR-CODE.

14. The confidential document transmission method according to claim 8, wherein the password QR-CODE is a text QR-CODE or an image QR-CODE, which comprises characteristic information of the sender or the receiver email mailbox.

15. A confidential document transmission system, comprising:
a cloud storage space; and
a multi-function printer (MFP) connected to the cloud storage space through the Internet, wherein the MFP comprises a scanner and a QR-CODE generator, wherein when a sender scans a document through the scanner, the MFP scans and sends the document to a cloud space address in the cloud storage space, the QR-CODE generator generates an address QR-CODE based on the cloud space address and a password QR-CODE based on the document scanned, the address QR-CODE is sent to a receiver email mailbox of a receiver, and the password QR-CODE is outputted to the sender.

16. The confidential document transmission system according to claim 15, wherein the MFP prints out the password QR-CODE in paper format.

17. The confidential document transmission system according to claim 15, wherein the MFP sends the password QR-CODE to a sender email mailbox of the sender.

18. The confidential document transmission system according to claim 15, wherein the document is a confidential document, and the MFP allows the sender to enter a confidential document scanning function, wherein the MFP pre-stores a sender email mailbox of the sender, and the sender selects the corresponding sender email mailbox and enters the confidential document scanning function to scan the document through the scanner of the MFP.

19. The confidential document transmission system according to claim 15, wherein the password QR-CODE is a text QR-CODE or an image QR-CODE, which comprises characteristic information of the sender or the receiver email mailbox.

20. The confidential document transmission system according to claim 15, wherein the receiver logs in to the cloud space address according to the address QR-CODE, and access the document according to the password QR-CODE.
